(19) United States
(12) Patent Application Publication
(10) Pub. No.: US 2016/0214620 A1
(43) Pub. Date: Jul. 28, 2016

(54) Device For Performing A Camera-Based Estimation Of Load On A Vehicle And Method Of Estimating Load On A Vehicle

(71) Applicant: LG ELECTRONICS INC., Yeongdeungpo-gu, Seoul (KR)

(72) Inventor: Jaehyuk YANG, Seoul (KR)

(73) Assignee: LG Electronics, Inc., Yeongdeungpo-gu, Seoul (KR)

(21) Appl. No.: 15/024,082

(22) PCT Filed: Dec. 13, 2013
(86) PCT No.: PCT/KR2013/011610

§ 371 Date: Mar. 23, 2016

(30) Foreign Application Priority Data
Oct. 8, 2013 (KR) 10-2013-0119983

(51) Int. Cl. B60W 40/13; G06K 9/62; B60C 23/00; G06K 9/00; B60T 7/12; B60H 1/00

(52) U.S. Cl. CPC B60W 40/13; B60T 7/12; B60H 1/00735; B60C 23/004; G06K 9/00791; G06K 9/6202; G06K 9/6215; B60W 2420/42

(57) ABSTRACT

Disclosed is a device for performing a camera-based estimation of load on a vehicle, including a camera for obtaining an external image of what is seen from in front of the vehicle, a setting unit that sets a reference line with respect to a first image that is obtained through the camera, and a controller that, when pitching or rolling is detected in the vehicle, detects a comparison line that corresponds to the reference line with respect to the first image, from a second image that is obtained through the camera, and estimates an addition to or a reduction from load on the vehicle according to the extent to which the detected comparison line deviates from the reference line. The controller estimates the addition to, or the reduction from the load on the vehicle, based on the extent to which the detected comparison deviates from the reference line.

### TECHNICAL FIELD

The present invention relates to a device for performing a camera-based estimation of load on a vehicle and a method of estimating load on a vehicle.

### BACKGROUND ART

In recent years, multiple camera sensors and intelligent processing technologies have been integrated to improve stability of a vehicle. Thus, the vehicle can be equipped with an advanced driver assistance system (ADAS) that executes a lane departure warning function, a collision avoidance function, a blind spot monitoring function, and a surround view function that includes an improved rear monitoring camera function and an object detection function.

For example, the advanced driver assistance system (ADAS) obtains information on distance between the vehicles and between the vehicle and an obstacle using information that is generated through the camera or a radar. In addition, based on the information on distance, a driving speed of the present vehicle is compared with a driving speed of the preceding vehicle. Then, the time to operate the ADAS is determined by calculating the collision forecast time, based on the predetermined time-to-collision (TTC).

However, the pieces of information described above lack reliability when the road surface is in a poor state or when load on the vehicle changes. Accordingly, a piezoelectric sensor is installed under the road surface or a change in minute angle is measured using a leaf spring wheel (a device for measuring load on the vehicle), in order to measure the load on the vehicle while driving, leaf spring wheel. However, the method of measuring the load on the vehicle in the related art has disadvantages that the piezoelectric sensor is installed under the road surface and that the measurement of the load on the vehicle is possible only in the vehicle equipped with the leaf spring wheel.

### DISCLOSURE OF INVENTION

### Technical Problem

Therefore, an object of the present invention is to provide a device for performing a camera-based estimation of load on a vehicle, which estimates a change in the load on the vehicle from an image obtained through a camera installed in the vehicle without having to install a separate sensor within the vehicle or in a road and uses information on the estimated load in operating an advanced driver assistance system (ADAS) and a method of estimating load on a vehicle.

### Solution to Problem

To achieve these and other advantages and in accordance with the purpose of the present invention, as embodied and broadly described herein, there is provided a device for performing a camera-based estimation of load on a vehicle, including a camera for obtaining an external image of what is seen from in front of the vehicle, a setting unit that sets a reference line with respect to a first image that is obtained through the camera, and a controller that, when pitching or rolling is detected in the vehicle, detects a comparison line that corresponds to the reference line with respect to the first image, from a second image that is obtained through the camera, and estimates an addition to or a reduction from load on the vehicle according to the extent to which the detected comparison line deviates from the reference line.

In the device, when the addition to or the reduction from the load on the vehicle is estimated, the controller may update the detected comparison line to the reference line, and may perform control in such a manner that the addition to, or the reduction from the load on the vehicle is estimated based on the reference line to which the detected comparison line is updated.

In the device, when a movement of the vehicle is detected in a state where the detected comparison line is consistent with the reference line, the controller may generate a control signal for operating an automatic emergency braking system of the vehicle and may provide the generated control signal to the vehicle.

In the device, the controller may estimate the addition to, or the reduction from the load on the vehicle according to a distance by or a direction in which pixels in the detected comparison line deviate from pixels in the reference line.

In the device, when the pixels in the detected comparison line are arranged in parallel in a first direction with respect to the pixels in the reference line, the controller may estimate that the load for the vehicle is additionally applied to a front seat in the vehicle, and when the pixels in the detected comparison line are arranged in parallel in a second direction with respect to the pixels in the reference line, the controller may estimate that the load for the vehicle is additionally applied to a rear seat in the vehicle.

In the device, the controller may estimate that the load on the vehicle is increased in proportion to the distance by which the pixels in the comparison line, which are arranged in the first direction or in the second direction, deviate from the pixels in the reference line.

In the device, when an arrangement of the pixels in the detected comparison line is changed in direction from the first direction or the second direction to a direction that is consistent with a direction of the pixels in the reference line, the controller may estimate that the load on the vehicle is reduced.

In the device, when the pixels in the detected comparison line are arranged in such a manner as to be inclined in a third direction with respect to the pixels in the reference line, the controller may estimate that the load for the vehicle is additionally applied to a left side of the vehicle, and when the pixels in the detected comparison line are arranged in such a manner as to be inclined in a fourth direction with respect to the pixels in the reference line, the controller may estimate that the load for the vehicle is additionally applied to a right side of the vehicle.

In the device, the controller may estimate that the load on the vehicle is increased in proportion to the extent to which the pixels in the comparison line, which are arranged in the third direction or in the fourth direction, are inclined from the pixels in the reference line.

In the device, in response to the arrangement of the pixels in the detected comparison line in an inclined manner in the third direction or in the fourth direction, the controller may obtain positional information on a passenger who rides in the vehicle.

The device may further include a communication unit that transmits a control signal for controlling operation of an intelligent advanced driver assistance system (ADAS) of the vehicle, based on the estimated load on the vehicle.

In the device, the controller may generate the control signal for adjusting a braking distance for the vehicle, based on the estimated load on the vehicle and may control the communication unit in such a manner that the generated control signal is transmitted to the vehicle.

In the device, the controller may generate the control signal for adjusting an economical speed for the vehicle, based on the estimated load on the vehicle and may control the communication unit in such a manner that the generated control signal is transmitted to the vehicle.

In the device, the controller may generate the control signal for adjusting at least one of a speed of cold/warm air and a direction of cold/warm air within the vehicle, based on the estimated load on the vehicle and may control the communication unit in such a manner that the generated control signal is transmitted to the vehicle.

In the device, the controller may generate the control signal for adjusting a pneumatic pressure of a tire installed in the vehicle, based on the estimated load on the vehicle and may control the communication unit in such a manner that the generated control signal is transmitted to the vehicle.

To achieve these and other advantages and in accordance with the purpose of the present invention, as embodied and broadly described herein, there is provided a method of estimating load on a vehicle equipped with a camera for obtaining an external image of what is seen from in front of the vehicle, the method including setting a reference line with respect to a first image that is obtained through the camera, detecting a comparison line that corresponds to the reference line with respect to the first image, from a second image that is obtained through the camera, when pitching or rolling is detected in the vehicle, and estimating an addition to or a reduction from load on the vehicle according to the extent to which the detected comparison line deviates from the reference line.

The method may further include updating the detected comparison line to the reference line when it is estimated that the addition to, or the reduction from the load to the vehicle and performing control in such a manner that the addition to, or the reduction from the load on the vehicle is estimated based on the reference line to which the detected comparison line is updated.

In the method, the estimating of the addition to or the reduction from the load on the vehicle may include estimating that the load for the vehicle is additionally applied to a front seat in the vehicle when the pixels in the detected comparison line are arranged in parallel in a first direction with respect to the pixels in the reference line and estimating that the load for the vehicle is additionally applied to a rear seat in the vehicle when the pixels in the detected comparison line are arranged in parallel in a second direction with respect to the pixels in the reference line.

In the method, the estimating of the addition to or the reduction from the load on the vehicle may include estimating that the load for the vehicle is additionally applied to a left side of the vehicle when the pixels in the detected comparison line are arranged in such a manner as to be inclined in a third direction with respect to the pixels in the reference line and estimating that the load for the vehicle is additionally applied to a right side of the vehicle when the pixels in the detected comparison line are arranged in such a manner as to be inclined in a fourth direction with respect to the pixels in the reference line.

The method may include transmitting a control signal for controlling operation of an intelligent advanced driver assistance system (ADAS) of the vehicle, based on the estimated load on the vehicle.

### Advantageous Effects of Invention

As described above, in the device for performing a camera-based estimation of load on a vehicle and the method of estimating the load on the vehicle according to the embodiment of the present invention, the change in the load on the vehicle while driving is estimated using the external image that is obtained through the camera, without having to install a separate load measurement sensor in the vehicle or in the road. As a result, the operation of the intelligent advanced driver assistance system (ADAS), such as adjusting the braking distance for the vehicle, can be managed with high efficiency. In addition, since the position in which the load on the vehicle while driving changes is estimated using the external image that is obtained through the camera, the intelligent advanced driver assistance system (ADAS) is made to provide the safety and the convenience in which the position of the passenger is suitably taken into consideration.

### BRIEF DESCRIPTION OF DRAWINGS

FIG. 1 is a block diagram illustrating a configuration of a device for performing a camera-based estimation of load on a vehicle according to one embodiment of the present invention.

FIG. 2 is a diagram illustrating that a reference line with respect to an external image captured through a camera changes depending on a change in load on a vehicle according to one embodiment of the present invention.

FIG. 3 is an exemplary flowchart for a method of estimating load on the vehicle according to one embodiment of the present invention.

FIGS. 4a to 4c are diagrams for describing the fact that the reference line changes depending on the extent to which the load is additionally applied to the vehicle according to one embodiment of the present invention.

FIGS. 5a to 5c are diagrams for describing operational control of an intelligent advanced driver assistance system (ADAS) of the vehicle using the device for performing a camera-based estimation of load on a vehicle according to one embodiment of the present invention.

### MODE FOR THE INVENTION

Reference will now be made in detail to the preferred embodiments of the present invention, examples of which are illustrated in the accompanying drawings. It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

The technical terms used in the present specification are set forth to mention specific embodiments of the present invention, and do not intend to define the scope of the present invention. As far as not being defined differently, all terms used herein including technical or scientific terms may have the same meaning as those generally understood by an ordinary person skilled in the art to which the present disclosure belongs to, and should not be construed in an excessively comprehensive meaning or an excessively restricted meaning. In addition, if a technical term used in the description of the present disclosure is an erroneous term that fails to clearly express the idea of the present disclosure, it should be replaced by a technical term that can be properly understood by the skilled person in the art. In addition, general terms used in the description of the present disclosure should be construed according to definitions in dictionaries or according to its front or rear context, and should not be construed to have an excessively restrained meaning.

A singular representation may include a plural representation as far as it represents a definitely different meaning from the context. Terms ‘include’ or ‘has’ used herein should be understood that they are intended to indicate an existence of several components or several steps, disclosed in the specification, and it may also be understood that part of the components or steps may not be included or additional components or steps may further be included.

In the following description, usage of suffixes such as ‘module’, ‘part’ or ‘unit’ used for referring to elements is given merely to facilitate explanation of the present invention, without having any significant meaning by itself.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

Preferred embodiments of the present invention will be described below in detail with reference to the accompanying drawings where those components are rendered the same reference number that are the same or are in correspondence, regardless of the figure number, and redundant explanations are omitted.

In describing the present invention, if a detailed explanation for a related known function or construction is considered to unnecessarily divert the gist of the present invention, such explanation has been omitted but would be understood by those skilled in the art. The accompanying drawings are used to help easily understood the technical idea of the present invention and it should be understood that the idea of the present invention is not limited by the accompanying drawings.

A device for performing a camera-based estimation of load on a vehicle according to an embodiment of the present invention is realized in such a manner as to estimate a change in load on the vehicle while driving using an external image obtained by a camera and further to estimate a position where the load on the vehicle is changed. This makes it possible to control operation of an intelligent advanced driver assistance system (ADAS) for its suitability for the load on the vehicle and for a position and a weight of a passenger.

First, FIG. 1 is a block diagram illustrating a configuration of the device for performing an estimation of load on a vehicle according to one embodiment of the present invention.

As illustrated in FIG. 1, the device for performing load on a vehicle 100 is configured to include a camera 110, a setting unit 120, and a controller 150. In addition, the load-on-vehicle estimation device 100 further includes a communication unit 180 for communicating with a vehicle 200 and/or an advanced driver assistance system (ADAS) and a memory 160.

The vehicle 200 means a possible carrier that is realized using a machine and an electronic apparatus to take people or things from one place to another, such as a passenger car, a bus, a train, a ship, and an airplane.

The camera 110 photographs an external image of the vehicle, particularly, an external image of what is seen from in front of the vehicle, according to a drive signal and obtains the photographed external image.

The camera 110 is at least one pair of cameras (for example, a stereo camera or stereoscopic camera) that is installed in such a manner that the cameras are spaced and arranged relative to each other horizontally on a centerline axis on a same an arbitrary same plane, or a single camera. At this time, if the camera 110 is provided in one pair, the fixed spacing is determined taking spacing between front left and right wheels into consideration.

In addition, the camera 110 is an arbitrary camera, each capable of capturing an image. In addition, if installed within the vehicle 200 or connected to the vehicle 100 for installation, the camera 110 is fixed to a predetermined position in the vehicle and is configured in such a manner as to photograph what is seen from in front of the vehicle in a driving direction and receive the captured image.

The setting unit 120 sets a reference line with respect to a first image obtained through the camera 110.

Here, the reference line is, for example, a centerline (for example, a transverse line with flatness of 0) that transversely divides the first image into equal two parts. In addition, the reference line has a predetermined slope that depends on the center of mass of the vehicle. For example, if the first image is obtained in a state where the center of mass of the vehicle is inclined in the A direction, the reference line is the transverse line that is inclined by a predetermined angle in the A direction.

In addition, the first image is an image that is obtained if no load is applied to the vehicle or if only a driver rides in the vehicle. In addition, the first image is an image that is obtained before a second image described below is obtained.

In this manner, when the reference line with respect to the first image is set, the controller 150 performs control in such a manner that a mark corresponding to the reference line is output on a front glass of the vehicle 200. In addition, the controller 150 changes the mark in such a manner that the mark corresponds to change of the reference line. According, the driver visually recognizes the change of the reference line and understands the change in the load on the vehicle as described below.

The controller 150 controls overall operation of the load-on-vehicle estimation device 100.

Specifically, when pitching or rolling is detected in the vehicle, the controller 150 detects a comparison line corresponding to the reference line with respect to the first image from the second image obtained by the camera 110.

Here, the pitching means that the vehicle 200 is shaken backwards and forwards, and the rolling means that the vehicle 200 is shaken from left to right. The pitching and/or rolling occurs due to vibration that is generated when the vehicle is driving on a bumpy road (when the vehicle is driving around a corner at a high speed) or when a passenger rides in the vehicle (that is, due to the change in the load to the vehicle). That is, because the pitching or the rolling occurs when another passenger rides in the vehicle, the controller 150 obtains the second image by driving the camera 110 in order to estimate the change in the load on the vehicle when the pitching or the rolling occurs.

Here, the second image is the external image of what is seen from in front of the vehicle, which is obtained through the camera 110 after a predetermined time elapses from when the first image is obtained.

In addition, the comparison line corresponding to the first image with respect to the reference line means a set of pixels that correspond to a set of pixels for the reference line when the reference line that is set with respect to the first image is transferred to the second image different from the first image. For example, when an angle of the photographed second image is inclined by “b” in the direction “a” with respect to an angle of the first image, it is detected that the comparison line corresponding to the reference line with respect to the first image also is inclined by “b” in the direction “a.”

When the comparison line is detected in this manner, the controller 150 estimates an addition to or a reduction from the load on the vehicle according to the extent to which the detected comparison line deviates from the reference line (that is, according to the extent to which the detected comparison line is consistent with the reference line).

Specifically, if a predetermined time elapses from when the first image is obtained or if the vehicle in a stop state starts to drive, the controller 150 detects the comparison line corresponding to the reference line with respect to the first image from the second image obtained by the camera 110.

When the addition to or the reduction from the load on the vehicle is estimated in this manner, the controller 150 performs control in such a manner that the detected comparison is updated to the reference line and then the addition to or the reduction from the load on the vehicle is estimated based on the reference line to which the detected comparison is updated.

That is, when the reference line with respect to the image that is obtained immediately before is transferred to the newly-obtained image, the load on the vehicle is continuously estimated based on the extent to which the reference line changes.

When the addition to or the reduction from the load on the vehicle is estimated, in this manner, through the reference line with respect to the image that is obtained through the camera 110, control of the operation of the intelligent advanced driver assistance system (ADAS) is possible based on estimated load information.

According to one embodiment, when a movement of the vehicle is detected in a state where the detected comparison line is consistent with the reference line, the controller 150 generates a control signal for operating an automatic emergency braking system (AEBS) of the vehicle and provided the generated control signal to the vehicle.

Here, the automatic emergency braking system (AEBA) refers to a system that, when the driver does not notice a different vehicle driving ahead or an obstacle placed ahead and thus the vehicle gets closer and closer to the different vehicle or the obstacle, automatically controls a speed or applies a brake. Generally, a distance to the vehicle driving ahead and to the obstacle is detected through a sensor.

In addition, here, the first image, in which the reference line is set, assumes that no load is applied to the vehicle, that is, that even the driver does not ride in the vehicle. That is, according to the embodiment of the present invention, if the vehicle moves although there is no change in the reference line in the external image captured by the camera (although there are no driver and passenger who ride in the vehicle), the control signal is transmitted to AEBS in order to operate the brake in the vehicle for the sake of safety. This precaution is taken to prevent all possible accidents.

As described above, in the device for performing a camera-based estimation of load on a vehicle according to the embodiment of the present invention, the change in the load on the vehicle while driving is estimated using the external image that is obtained through the camera, without having to install a separate load measurement sensor in the vehicle or in the road. Accordingly, a vehicle environment is provided in which the operation of the intelligent advanced driver assistance system (ADAS), such as adjusting a braking distance, is executed in a more efficient manner.

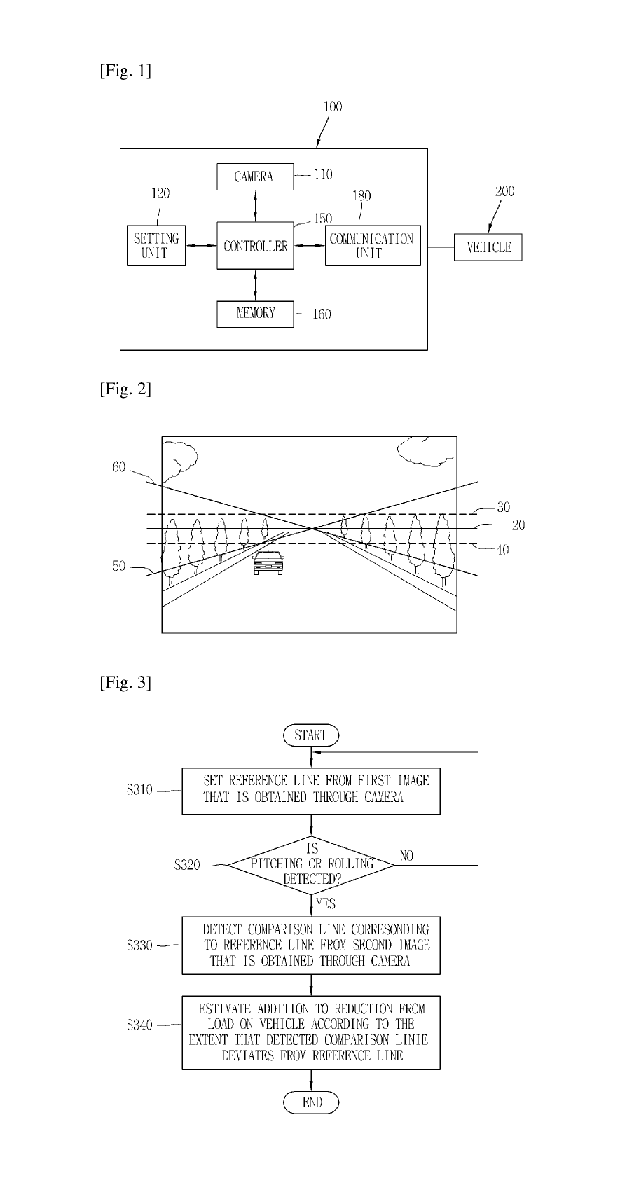

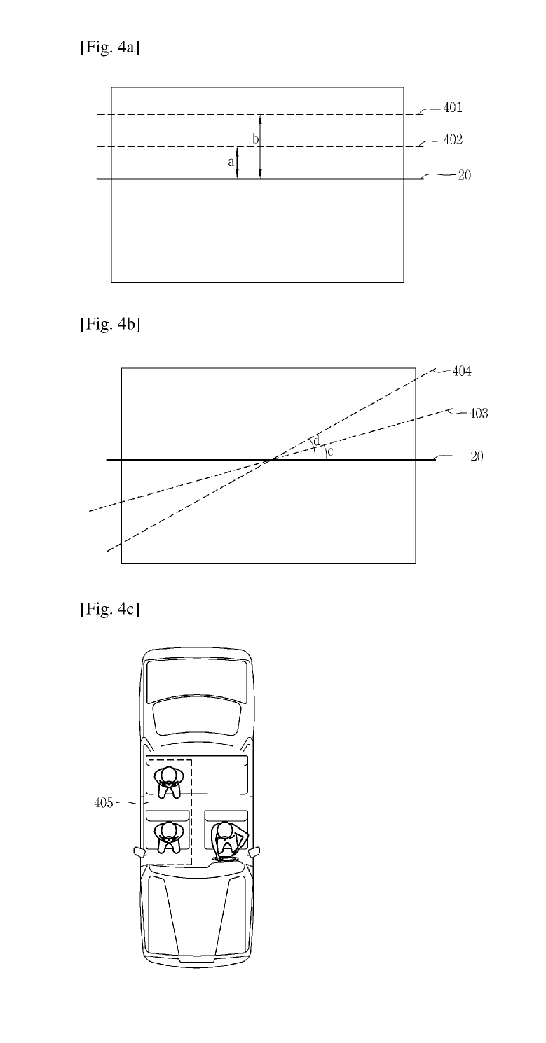

The estimation of the change in the load on the vehicle according to the change of the reference line that is set, in the external image captured through the camera, is described below referring to FIG. 2, FIG. 3 and FIGS. 4a to 4c.

In this context, FIG. 2 is a diagram illustrating that the reference line with respect to the external image captured through the camera changes depending on the change in the load on the vehicle according to one embodiment of the present invention. In this context, FIG. 3 is an exemplary flowchart for a method of estimating the load on the vehicle according to one embodiment of the present invention.

First, referring to FIG. 3, the load-on-vehicle estimation device 100 described above includes the camera 110 for obtaining the external image of what is seen from in front of the vehicle, and the reference line is set in the obtained first image by driving the camera according to the drive signal or according to initial calibration (S310).

Here, the first image is the image that is obtained if no load is applied to the vehicle or if only the driver rides in the vehicle. In addition, the first image is the image that is obtained before a second image described below is obtained.

Then, when the pitching or the rolling is detected in the vehicle (S320), the load-on-vehicle estimation device 100 of the vehicle detects the comparison line corresponding to the reference line from the second image obtained by the camera 110 (S330).

Here, the second image is the external image of what is seen from in front of the vehicle, which is obtained through the camera 110 after the predetermined time elapses from when the first image is obtained.

In addition, the comparison line corresponding to the first image with respect to the reference line means the set of pixels that correspond to the set of pixels for the reference line when the reference line that is set with respect to the first image is transferred to the second image different from the first image.

Then, the addition to or the reduction from the load on the vehicle is estimated according to the extent to which the comparison line that is detected in this manner deviates from the reference line with respect to the first image (S340).

Specifically, the controller 150 of the load-on-vehicle estimation device 100 estimates the addition to or the reduction from the load on the vehicle according to a distance by and a direction in which the pixels in the detected comparison line deviates from the pixels in the reference line.

As one example, when the pixels in the detected comparison line are arranged in parallel in a first direction (for example, in the upward direction) with respect to the pixels in the reference line, the controller 150 estimates that the load is additionally applied to a “front seat” in the vehicle.

Similarly, when the pixels in the detected comparison line are arranged in parallel in a second direction (for example, in the downward direction) with respect to the pixels in the reference line, the controller 150 estimates that the load is additionally applied to a “rear seat” in the vehicle.

For example, in FIG. 2, because the center of mass of the vehicle is inclined forwards when the passenger sits on the “front seat” in the vehicle, a reference line 20 with respect to an image of what is seen from in front of the vehicle, which is obtained in an initial state of the vehicle corresponding to the first image or in an updated calibration state, moves in the upward direction (in the direction opposite to the road surface). Accordingly, the reference line 20 moves in the upward direction by a distance corresponding to an additional load to the vehicle. A first comparison line 30 is detected that results from the reference line 20 moving in the upward direction by the distance.

In contrast, because the center of mass of the vehicle is inclined backwards when the passenger sits on the “rear seat” in the vehicle, the reference line 20 moves in the downward direction (in the direction of the road surface). Accordingly, the reference line 20 moves in the downward direction by a distance corresponding to an additional load to the vehicle. A second comparison line 40 is detected that results from the reference line 20 moving in the downward direction by the distance.

On the other hand, when an arrangement of the pixels in the detected comparison line is changed in direction from the first direction or the second direction to a direction that is consistent with that of the pixels in the reference line, the controller 150 estimates that the load on the vehicle is reduced. When it is estimated in this manner that the load on the vehicle is reduced, the reference line is again calibrated according to the current load on the vehicle, which is reduced.

In addition, as one example, when the pixels in the detected comparison line are arranged in such a manner as to be inclined in a third direction (for example, in the rightward direction) with respect to the pixels in the reference line, the controller 150 estimates that the load is additionally applied to a “left side” of the vehicle.

Similarly, when the pixels in the detected comparison line are arranged in such a manner as to be inclined in a fourth direction (for example, in the leftward direction) with respect to the pixels in the reference line, the controller 150 estimates that the load is additionally applied to a “right side” of the vehicle.

For example, in FIG. 2, because the center of mass of the vehicle is inclined to the left when more passengers sit on the “left side” of the vehicle than on the “right side,” or when a heavier passenger sits on the “left side” of the vehicle than on the “right side, the reference line 20 with respect to an image of what is seen from in front of the vehicle, which is obtained in the initial state of the vehicle corresponding to the first image or in the updated calibration state, is inclined in the rightward direction in the image. Accordingly, the reference line 20 is inclined in the rightward direction by a degree corresponding to an additional load to the left side of the vehicle. A third comparison line 60 is detected that results from the reference line 20 moving in the rightward direction by the degree.

In contrast, because the center of mass of the vehicle is inclined to the right when more passengers sit on the “right side” of the vehicle than on the “left side,” or when a heavier passenger sits on the “right side” of the vehicle than on the “left side, the reference line 20 is inclined in the leftward direction in the image. Accordingly, the reference line 20 is inclined in the leftward direction by a degree corresponding to an additional load to the right side of the vehicle. A fourth comparison line 50 is detected that results from the reference line 20 moving in the leftward direction by the degree.

In addition, in response to the arrangement of the pixels in the detected comparison line in an inclined manner in the third direction or in the fourth direction, the controller 150 obtains positional information on the passenger who rides in the vehicle. For example, in FIG. 2, if the pixels in the detected comparison line are arranged in such a manner as to be inclined to the right, it is estimated that the load is applied to the “left side” of the vehicle (or the passenger sits on the “left side”) or that the left side is under a large amount of load than the right side.

In addition, the controller 150 estimates not only the position on which the passenger sits, but also the approximate weight of the passenger, reflecting changes in distance and inclination by which the reference line deviates from the previous reference line. To do this, a distance change value and/or an inclination change value for the reference line that correspond(s) to an added amount of load are stored in advance in the memory 160. The controller 150 estimates specific information, such as the appropriate weight of the passenger and information as to whether the passenger is an adult or a child, based on the stored distance change value and/or inclination change value.

On the other hand, based on the information on the change of the reference line by the load-on-vehicle estimation device 100, the controller 150 generates the control signal for controlling the operation of the intelligent advanced driver assistance system (ADAS) of the vehicle and transmits the generated control signal to the vehicle.

In addition, when the presence or absence of the change in the load on the vehicle is estimated by the load-on-vehicle estimation device 100, thereafter, the controller 150 performs control in such a manner that the detected comparison line is updated to the reference line. Accordingly, a load estimation to be performed the next time is made to be performed according to the extent to which the reference line to which the detected comparison line is updated changes.

An estimation of the extent to which the load is additionally applied to the vehicle is described below. The estimation is based on the distance and/or inclination by which the reference line that is set deviates from the previous reference line in the external image captured through the camera.

FIGS. 4a to 4c are diagrams for describing the fact that the reference line changes depending on the extent to which the load is additionally applied to the vehicle according to one embodiment of the present invention.

The controller 150 of the load-on-vehicle estimation device 100 according to the embodiment of the present invention, as described above, estimates the addition to or the reduction from the load on the vehicle according to the extent to which the pixels in the detected comparison line deviate from the pixels in the reference line with respect to the first image, that is, according to the distance and direction by which the pixels in the detected comparison line deviate from the pixels in the reference line.

At this time, the controller 150 estimates that the load on the vehicle is increased in proportion to the distance by which the pixels in the comparison line, which are arranged in parallel or in an inclined manner in the first direction or the second direction, deviate from the pixels in the reference line.

For example, in FIG. 4a, when the reference line 20 with respect to the external image of what is seen from in front of the vehicle is moved by a distance a in the upward direction (402) if the load is applied to the front seat in the vehicle (for example, if the passenger sits next to the driver), the reference line 20 is moved upwards by a distance b, farther away than the distance a (S401), when a larger amount of load is applied to the front seat in the vehicle than the previous load (for example, the passenger who sits next to the driver is heavier than the previous passenger) (401). On the other hand, although not illustrated, the movement (or the change) of the reference line described above is displayed on the front glass and the like so that the driver can immediately recognize the movement (or the change) of the reference line.

In addition, the controller 150 estimates that the load on the vehicle is increased in proportion to the extent to which the pixels in the comparison line, which are arranged in an inclined manner in the third direction or the fourth direction, is inclined from the pixels in the reference line.

For example, when the reference line 20 with respect to the external image of what is seen from in front of the vehicle is moved in such a manner as to be inclined by an angle c in the leftward direction as illustrated in FIG. 4b (403) if the load, as illustrated in FIG. 4c, is applied to the right side of the vehicle (for example, the passengers sit on the seat next to the driver seat and on the rear seat behind the driver seat), the reference line 20 is moved in such a manner as to be inclined leftwards by an angle d, greater than the angle c (404), if a larger amount of load is applied to the right side of the vehicle than the previous load (for example, if the passenger(s) who sit on the seat next to the driver seat and/or on the rear seat behind the seat next to the driver seat is heavier than the previous passenger(s). On the other hand, although not illustrated, the movement (or the change) of the reference line described above is displayed on the front glass and the like so that the driver can immediately recognize the movement (or the change) of the reference line.

As described above, in the device for performing a camera-based estimation of load on a vehicle according to the embodiment of the present invention, the position and the weight of the passenger can be roughly estimated by estimating the position in which the load on the vehicle while driving changes and the extent to which the load is additionally applied to the vehicle.

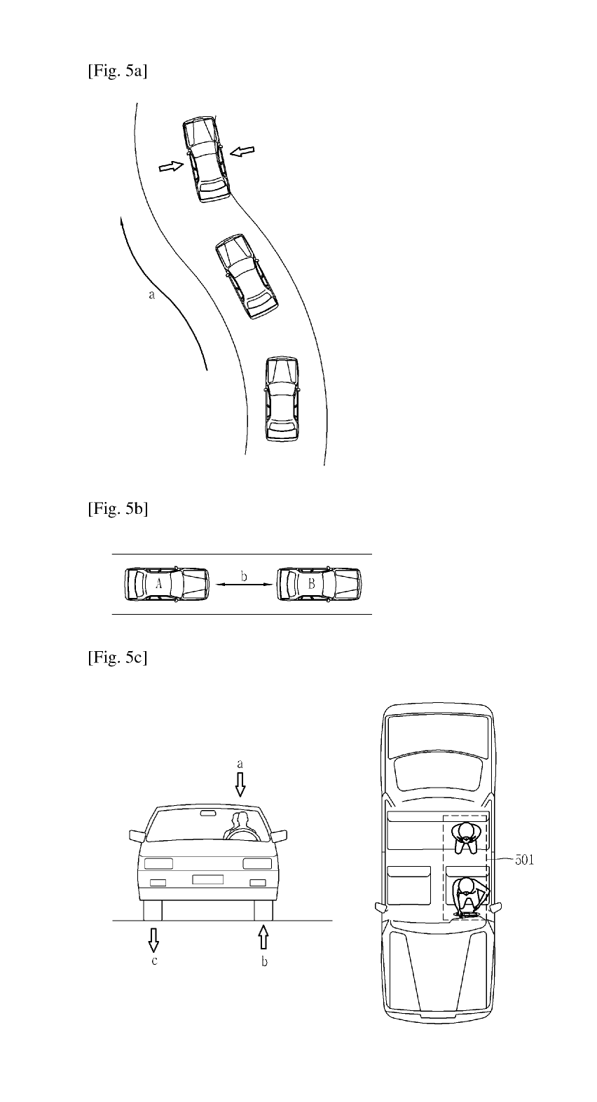

Operational Control of an electronic device and an electronic control device included in the advanced driver assistance system (ADAS) in the vehicle is described below referring to FIGS. 5a to 5c. The operation control is based on the change in the load that is estimated through the device for performing a camera-based estimation of load on a vehicle 100.

FIGS. 5a to 5c are diagrams for describing operational control of the intelligent advanced driver assistance system (ADAS) of the vehicle using the load-on-vehicle estimation device of the vehicle according to one embodiment of the present invention.

To do this, the load-on-vehicle estimation device 100 includes the communication unit 180 that transmits the control signal for controlling the operation of the intelligent advanced driver assistance system (ADAS) of the vehicle, based on the estimated load on the vehicle.

At this time, the load-on-vehicle estimation device 100 and the vehicle 200 or devices of the ADAS of the vehicle transmit and receive a predetermined control signal to and from each other using a controller area network (CAN) bus.

Here, the controller area network (CAN) bus means a standard communication specification designed to allow the electronic device and the electronic control devices to communicate with each other without a host computer within the vehicle. The CAN bus is a message-based protocol and is used for communication within the vehicle. Information generated by the load-on-vehicle estimation device 100 is received and a message corresponding to the received information is generated according to the CAN protocol specification and is data-processed over a network. Thereafter, the message is converted into a signal suitable for the corresponding intelligent advanced driver assistance system (ADAS) and the signal is transmitted to the intelligent ADAS.

As an example of this, based on the estimated load on the vehicle, the controller 150 controls the communication unit 180 in such a manner that the control signal for adjusting the braking distance for the vehicle is generated and the generated control signal is transmitted to the vehicle.

Here, the braking distance for the vehicle means a distance that the vehicle moves from when the brake starts to operate in the vehicle while driving to when the vehicle comes to a stop. That is, the braking distance for the vehicle is not a distance that the vehicle moves at the instant when the drives pushes a brake pedal down, but the distance that the vehicle moves from when the brake starts to operate in the vehicle while driving to when the vehicle comes to a stop. Therefore, the time that the driver takes to respond to an urgent situation does not have any effect on the braking distance. The braking distance differs depending not only on a speed of the vehicle and a state of the road surface, but also on the addition to or the reduction from the load on the vehicle according to the present invention.

Because the more the load on the vehicle is increased, the greater the braking distance, the braking distance is set to be greater in order to prevent a possible collision with the vehicle driving ahead.

For example, in FIG. 5b, as the load on a vehicle A is more increased, the braking distance resulting from the quick brake is more increased. Thus, the control signal for setting a safety distance b to the vehicle driving ahead to be greater can be provided. When the safety distance b is decreased, the control signal for outputting a predetermined alarm is provided to alert the driver to the safety distance b being decreased. In addition, for example, in FIG. 5a, when the load on the vehicle is further increased, there is a high likelihood that when driving around a curve a, the vehicle will get out of its lane. Because of this, the control signal for outputting the predetermined alarm is provided to the vehicle in order for the driver to reduce the speed or apply the brake earlier than in ordinary days before driving around the corner.

As another example, based on the estimated load on the vehicle, the controller 150 generates the control signal for adjusting an economical speed for the vehicle and controls the communication unit 180 in such a manner that the generated control signal is transmitted to the vehicle.

Here, the economical speed means a speed at which the vehicle drives the greatest distance with the least fuel. Generally, the economical speed of the vehicle is 70 to 80 km/h. However, the economical speed differs depending on an increase or a decrease in the load on the vehicle.

Specifically, when it is estimated by the load-on-vehicle estimation device 100 that the load on the vehicle is increased, the controller 150 provides the control signal for decreasing a predetermined economical speed in proportion to an added amount of load that is estimated, to the vehicle through the communication unit 180.

Specifically, when it is estimated by the load-on-vehicle estimation device 100 that the load on the vehicle is decreased, the controller 150 provides the control signal for increasing a predetermined economical speed in proportion to a reduced amount of load that is estimated, or for returning the current speed to an initial speed, to the vehicle through the communication unit 180.

In addition, according to patterns of the change in the load on the vehicle that are accumulated for a given period of time, the controller 150 may determine whether or not to adjust the economical speed and the extent to which the economical speed is adjusted.

As another example, based on the estimated load on the vehicle, the controller 150 generates the control signal for adjusting at least one of a speed of cold/warm air and a direction of cold/warm air within the vehicle and controls the communication unit in such a manner that the generated control signal is transmitted to the vehicle.

For example, if the estimated load on the vehicle increases in excess of a reference value, the controller 150 generates the control signal for adjusting the speed of cold/warm air within the vehicle to a high level. In addition, if the estimated load on the vehicle decreases to a great extent, the controller 150 generates the control signal for adjusting the speed of cold/warm air within the vehicle to a low level. In addition, the controller 150 determines the direction of cold/warm air within the vehicle, based on information on the position of the passenger that is estimated according to the extents of the distance and inclination by which the detected comparison line deviates from the reference line.

As another example, based on the estimated load on the vehicle, the controller 150 generates the control signal for adjusting a pneumatic pressure of a tire installed in the vehicle and controls the communication unit in such a manner that the generated control signal is transmitted to the vehicle.

For example, referring to FIG. 5c, if the load for the vehicle is additionally applied to the driver seat of the vehicle and the rear seat arranged in parallel with the driver seat (501), the tire pneumatic pressure of front and rear wheels that correspond to the position a to which the load for the vehicle is additionally applied is increased, as much as the load is additionally applied, in the direction b opposite to the road surface. In addition, the tire pneumatic pressure of the wheels in front of and in rear of a position facing the position to which the load for the vehicle is additionally applied is decreased in the road-surface direction c. Accordingly, the vehicle is prevented from being inclined due to the change in the load on the vehicle is corrected.

As another example, the controller 150 adjusts an angle and a size of an airbag, have the passenger recognize whether or not he/she fastens a safety belt, or help the passenger correct his/her poor posture, based on the passenger information (for example, the information as to whether the passenger is an adult or a child, which is based on the position of the passenger and the weight of the passenger) that is estimated based on the estimated position in the vehicle to which the load is applied and the estimated extent to which the load is applied.

In addition, in the load-on-vehicle estimation device 100 according to the embodiment of the present invention, the vehicle system can be controlled with high accuracy according to the load information on the vehicle that is estimated by putting together pieces of second information that are obtained in conjunction with the camera in the rear side of the vehicle or the camera within the vehicle.

In addition, the load-on-vehicle estimation device 100 is connected to other electronic devices within the vehicle to control the operation of the vehicle system in various ways, using short-range communication standards, such as Bluetooth, wireless Internet standards, such as Wi-Fi, and external device interface standards, such as universal serial bus (USB).

As described above, in the device for performing a camera-based estimation of load on a vehicle and the method of estimating the load on the vehicle according to the embodiment of the present invention, the change in the load on the vehicle while driving is estimated using the external image that is obtained through the camera, without having to install a separate load measurement sensor in the vehicle or in the road. As a result, the operation of the intelligent advanced driver assistance system (ADAS), such as adjusting the braking distance for the vehicle, can be managed with high efficiency. In addition, since the position in which the load on the vehicle while driving changes is estimated using the external image that is obtained through the camera, the intelligent advanced driver assistance system (ADAS) is made to provide the safety and the convenience in which the position of the passenger is suitably taken into consideration.

In addition, according to one embodiment disclosed in the present specification, the method described above may be realized by being stored as processor-readable codes in a program-stored medium. A ROM, a RAM, a CD-ROM, a magnetic tape, a floppy disk, an optical data storage device and the like are examples of the processor-readable medium, and the processor-readable medium may be realized in the form of a carrier wave (for example, a transmission over the Internet).

The configuration and the method of the embodiments according to the present invention, described above, are not applied in a limiting manner, but all of or some of the embodiments may be selectively combined with each other to create various modifications to the embodiments.

It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

1. A device for performing a camera-based estimation of load on a vehicle, comprising:
a camera for obtaining an external image of what is seen from in front of the vehicle;
a setting unit that sets a reference line with respect to a first image that is obtained through the camera; and
a controller that, when pitching or rolling is detected in the vehicle, detects a comparison line that corresponds to the reference line with respect to the first image, from a second image that is obtained through the camera, and estimates an addition to or a reduction from load on the vehicle according to the extent to which the detected comparison line deviates from the reference line,
wherein when the addition to or the reduction from the load on the vehicle is estimated, the controller updates the detected comparison line to the reference line.

2. The device of claim 1, wherein the controller performs control in such a manner that the addition to, or the reduction from the load on the vehicle is estimated based on the reference line to which the detected comparison line is updated.

3. The device of claim 1, wherein, when a movement of the vehicle is detected in a state where the detected comparison line is consistent with the reference line, the controller generates a control signal for operating an automatic emergency braking system of the vehicle and provides the generated control signal to the vehicle.

4. The device of claim 1, wherein the controller estimates the addition to, or the reduction from the load on the vehicle according to a distance by or a direction in which pixels in the detected comparison line deviate from pixels in the reference line.

5. The device of claim 4, wherein, when the pixels in the detected comparison line are arranged in parallel in a first direction with respect to the pixels in the reference line, the controller estimates that the load for the vehicle is additionally applied to a front seat in the vehicle, and
wherein, when the pixels in the detected comparison line are arranged in parallel in a second direction with respect to the pixels in the reference line, the controller estimates that the load for the vehicle is additionally applied to a rear seat in the vehicle.

6. The device of claim 5, wherein the controller estimates that the load on the vehicle is increased in proportion to the distance by which the pixels in the comparison line, which are arranged in the first direction or in the second direction, deviate from the pixels in the reference line.

7. The device of claim 5, wherein, when an arrangement of the pixels in the detected comparison line is changed in direction from the first direction or the second direction to a direction that is consistent with a direction of the pixels in the reference line, the controller estimates that the load on the vehicle is reduced.

8. The device of claim 4, wherein, when the pixels in the detected comparison line are arranged in such a manner as to be inclined in a third direction with respect to the pixels in the reference line, the controller estimates that the load for the vehicle is additionally applied to a left side of the vehicle, and
wherein, when the pixels in the detected comparison line are arranged in such a manner as to be inclined in a fourth direction with respect to the pixels in the reference line, the controller estimates that the load for the vehicle is additionally applied to a right side of the vehicle.

9. The device of claim 8, wherein the controller estimates that the load on the vehicle is increased in proportion to the extent to which the pixels in the comparison line, which are arranged in the third direction or in the fourth direction, are inclined from the pixels in the reference line.

10. The device of claim 8, wherein in response to the arrangement of the pixels in the detected comparison line in an inclined manner in the third direction or in the fourth direction, the controller obtains positional information on a passenger who rides in the vehicle.

11. The device of claim 1, further comprising a communication unit that transmits a control signal for controlling operation of an intelligent advanced driver assistance system (ADAS) of the vehicle, based on the estimated load on the vehicle.

12. The device of claim 11, wherein the controller generates the control signal for adjusting a braking distance for the vehicle, based on the estimated load on the vehicle, and controls the communication unit in such a manner that the generated control signal is transmitted to the vehicle.

13. The device of claim 11, wherein the controller generates the control signal for adjusting an economical speed for the vehicle, based on the estimated load on the vehicle, and controls the communication unit in such a manner that the generated control signal is transmitted to the vehicle.

14. The device of claim 11, wherein the controller generates the control signal for adjusting at least one of a speed of cold/warm air and a direction of cold/warm air within the vehicle, based on the estimated load on the vehicle, and controls the communication unit in such a manner that the generated control signal is transmitted to the vehicle.

15. The device of claim 11, wherein the controller generates the control signal for adjusting a pneumatic pressure of a tire installed in the vehicle, based on the estimated load on the vehicle, and controls the communication unit in such a manner that the generated control signal is transmitted to the vehicle.

16. A method of estimating load on a vehicle equipped with a camera for obtaining an external image of what is seen from in front of the vehicle, the method comprising:
setting a reference line with respect to a first image that is obtained through the camera;
detecting a comparison line that corresponds to the reference line, from a second image that is obtained through the camera, when pitching or rolling is detected in the vehicle;
estimating an addition to or a reduction from load on the vehicle according to the extent to which the detected comparison line deviates from the reference line; and
performing control in such a manner that the detected comparison line is updated to the reference, after the estimating of the addition to or the reduction from the load on the vehicle.

17. (canceled)

18. The method of claim 16, wherein the estimating of the addition to or the reduction from the load on the vehicle includes estimating that the load for the vehicle is additionally applied to a front seat in the vehicle when the pixels in the detected comparison line are arranged in parallel in a first direction with respect to the pixels in the reference line and estimating that the load for the vehicle is additionally applied to a rear seat in the vehicle when the pixels in the detected comparison line are arranged in parallel in a second direction with respect to the pixels in the reference line.

19. The method of claim 16, wherein the estimating of the addition to or the reduction from the load on the vehicle includes estimating that the load for the vehicle is additionally applied to a left side of the vehicle when the pixels in the detected comparison line are arranged in such a manner as to be inclined in a third direction with respect to the pixels in the reference line and estimating that the load for the vehicle is additionally applied to a right side of the vehicle when the pixels in the detected comparison line are arranged in such a manner as to be inclined in a fourth direction with respect to the pixels in the reference line.

20. The method of claim 16, further comprising transmitting a control signal for controlling operation of an intelligent advanced driver assistance system (ADAS) of the vehicle, based on the estimated load on the vehicle.
